(19) United States
(12) Patent Application Publication
(10) Pub. No.: US 2004/0074365 A1
(43) Pub. Date: Apr. 22, 2004

(54) Angle-cut saw guide for wooden I-beams

(76) Inventors: Kim W. Nilsen, Bellevue, ID (US); Owen R. Downard, Bellevue, ID (US)

Correspondence Address: PEDERSEN & COMPANY, PLLC, P.O. BOX 2666, BOISE, ID, 83701, US

(21) Appl. No.: 10/274,338

(22) Filed: Oct. 17, 2002

(51) Int. Cl. B27B 9/04

(52) U.S. Cl. 83/745; 83/574

(57) ABSTRACT

A saw guide for hand-held power saws may be adjusted for cutting of wooden I-beams at various angles to the length of the I-beam. A first member abuts one flange, and a second member abuts the other flange, of the I-beam. The second member includes an elongated horizontal surface for support of the saw, and an elongated vertical guide surface for guiding the saw in a straight line to create the straight cut. The second member is pivotable in a horizontal plane and lockable relative to the first member to set and lock the position of the guide surface relative to the first member and the I-beam. The second member preferably includes an adjustable stop that is moveable and lockable to various positions on the second member to place the stop against the inner surface of the second flange no matter at what the angle of second member is set. By securing the saw guide with a friction fit “inside” the web and flanges, rather than outside the flanges or around the flanges, the saw guide securely and non-rotatably installed and, yet, is easily removed for subsequent use and repeated use on many I-beams.

### BACKGROUND OF THE INVENTION

1. Field of the Invention

This invention relates generally to saw guides for portable power saws. More specifically, this invention relates to saw guides for making angled cuts of wooden I-beams, such as are desired for roof and other corner structures.

2. Related Art

Wooden I-beams have become popular as construction materials. Typically, however, wooden I-beams are difficult to cut with a portable saw on the job site. This is because the I-beam has a center panel of plywood, called a “web,” bordered on both panel edges by two laminated-wood bars, called “cords” or “flanges,” that have a thickness typically 3-5 times the thickness of the web. When cutting across a wooden I-beam, the thickness difference between the two edge flanges and the central web makes it difficult for the carpenter to continue sawing on a straight line. The difficulty exists whether the cuts being made are perpendicular to the length, or at an angle to the length, of the I-beam.

Several saw guides have been designed for cutting beams. Downard et al. (U.S. Pat. No. 5,787,782, August 1998) illustrates a beam-cutting saw guide preferably free of moving parts and comprising, in effect, saw support surfaces, saw guide surfaces and bracing surfaces that are all fixed relative to each other in a given saw guide. Downard et al. discloses that, while the portrayed saw guide is designed for perpendicular cuts across the I-beam exactly normal to the longitudinal axis of the I-beam, other saw guide embodiments may have the support surfaces, guide surfaces, and brace surfaces oriented to result in cuts across the I-beam at angles other than 90°.

DeFelice et al. (U.S. Pat. No. 5,983,767, November 1999) describes a saw guiding device that is a generally right-triangular piece with various holes along its hypotenuse. One corner end of one edge of the device rests against the outside surface of one of the flanges of the I-beam. A movable workpiece-edge engaging peg is fixable in the various holes and rests against the same outside surface of the flange at a distance from the one corner end, so as to set the angle of the hypotenuse relative to the I-beam (FIG. 8 of DeFelice et al.). The DeFelice et al. device has little structure for securing the device relative to the I-beam, but rather rests on top of the I-beam and abuts against the outer surface of one flange.

Ekker (U.S. Pat. No. 5,509,338, April 1996) discloses a saw guide with a first assembly that clamps onto one flange of an I-beam and includes an integral arm that extends out over the center of the web of the I-beam. Pivotally connected to the integral arm near the center of the I-beam, by means of a single wing-nut, is a second assembly the pivots to various angles relative to the I-beam. The first assembly clamping system abuts against and grips both the outer and inner surfaces of the one cord. The second assembly comprises a face plate (saw guide surface) that spans the cords of the I-beam, but has only a short saw support with a length only about ⅓ the length of the face place and therefore only about ⅓ as long as the width of the I-beam. The second assembly, therefore, contacts the top surfaces of the cords and the web top surface but not the inner or outer surfaces of the cords.

Sadler (U.S. Pat. No. 1,535,042, April, 1925) discloses a handsaw guide that is intended for angle-cuts of planks and boards. A first assembly of the Sadler device has a portion with a handle that abuts against a first outer edge surface of the plank and has a clamping bar the extends entirely across the plank and turns down at the outer end to form a clamping jaw that engages over the opposite outer edge surface of the plank opposite from the portion with the handle. A second assembly of this Sadler device is pivotally connected to the first assembly near the first outer edge surface. The second assembly extends over the plank but does not attach to the plank.

Still, there is a need for a secure and safe saw guide for accurate and precise angle-cutting of I-beams. There is a need for a light-weight saw guide that can be adjusted for angle-cutting, as well as perpendicular cutting. There is a need for a saw guide that may be very securely and safely installed on an I-beam, and, yet, that is economical to manufacture and simple to use. There is a need for a saw guide that fully supports a saw across the entire cut, for increased safety and accuracy.

### SUMMARY OF THE INVENTION

The present invention comprises a saw guide for use in cutting I-beams at a variety of angles relative to the longitudinal axis of the I-beam. The saw guide comprises a first member that rests against the inside of a flange, but preferably does not clamp to the flange. A second member of the saw guide serves as a saw support/guide. The second member pivots relative to the first member and has a member that rests against the inside of the opposite flange. With minimal structure, complexity, and moving parts, this design allows very secure placement of the saw guide on the web and in-between the flanges, in such a way that the invented saw guide does not tend to pivot, slide, or shift during use. Preferably, the invented saw guide is adjusted to fully and rigidly extend the entire distance between the inner surfaces of the two I-beam flanges, so there is no room for movement or rotation of the saw guide on the web during use. This secure installation, and the adjustability of the saw guide for various angles of cutting and various sizes of I-beams, are critical for safety and accuracy.

Preferably, the invented saw guide first member rests on the top surface of the web, and includes an abutment surface for contacting the inner surface of one flange, the “first flange,” but preferably does not clamp onto or attach to the flange. The first member preferably has an area adapted in size and orientation for acting as a handle, so that the user may him/her-self grasp the handle area of the saw guide at the same time and with the same hand that he/her grasps the first flange, thus further securing the saw guide relative to the I-beam and giving the user a further sense of security and orientation for accurate and safe cutting.

The saw guide second member pivotally connects to the first member, and extends entirely across the I-beam to rest on the top surfaces of both flanges no matter at what angle the second member is set relative to the first member, and, therefore, relative to the longitudinal axis of the I-beam. A linearly-adjustable stop member on the second member is movable and fixable at various locations along the length of the second member, preferably parallel to the saw guide surface of the second member, to abut against the inner surface of the second flange. Both the saw support surface and saw guide surface of the second member are substantially the same length, to provide elongated surfaces without any interruption across a distance greater than the entire width of the I-beam. The second member is supported by the flanges near the outer ends of the support surface, and is supported by the first member for a substantial distance along its central region, that is, underneath the second member about half way across the I-beam. Further, the stop member is preferably designed to extend all the way from the second member to contact the web surface, and is preferably a non-slick material for frictional gripping contact with the web surface and the second flange inner surface. These several supports, plus the second member being built to be strong and rigid, help prevent the second member from substantial bending or sagging into the web area.

### BRIEF DESCRIPTION OF THE DRAWINGS

FIG. 1 is a top view of one embodiment of the invented saw guide, positioned on an I-beam and adjusted for cutting across the I-beam at about 60 degrees to the longitudinal axis of the I-beam.

FIG. 2 is a top view of the saw guide of FIG. 1, adjusted for cutting across the I-beam at 90 degrees to the longitudinal axis of the I-beam.

FIG. 3 is a bottom view of the saw guide of FIGS. 1 and 2, removed from the I-beam.

FIG. 4 is an end view of the saw guide of FIGS. 1-3, in place on an I-beam as viewed from the lines 4-4 in FIG. 2.

FIG. 5 is an end view of the saw guide of FIGS. 1-4, in place on an I-beam as viewed from the lines 5-5 in FIG. 2.

### DESCRIPTION OF THE PREFERRED EMBODIMENTS

Referring to the Figures, there is shown one, but not the only, embodiment of the invented saw guide for angle-cutting of I-beams. The saw guide 10 comprises a first member 12 and second member 14, pivot system 16 that allows the second member 14 to pivot relative to the first member 12 to adjust the angle of the second member 14 to the first member 12, one or preferably a plurality of locks 18 to fix the chosen angle of second member to first member, and an adjustable stop system 20. As may be seen in the drawings, the preferred saw guide is made with many cut-outs or molded interior spaces to make the saw guide light weight and easy and economical to manufacture, and easy to handle.

The saw guide 10 sets on an I-beam 22 contacting the web 24 and the opposing two flanges 26,28. The bottom surface 32 of the first member 12 preferably rests flat on the web, that is, on web top surface 34. The bottom surface 36 of the second member 14 preferably rests on the top surfaces 27, 29 of the flanges 26, 28. Also, preferably, the bottom surface 38 of the snubber 21 also rests on the web top surface 34. Due to tolerances of manufacture of I-beams, however, when the second member rests on the flanges, the first member and the snubber may not rest on and contact the web in all cases, and this still produces an effective and operable cooperation between the invented saw guide 10 and the I-beam.

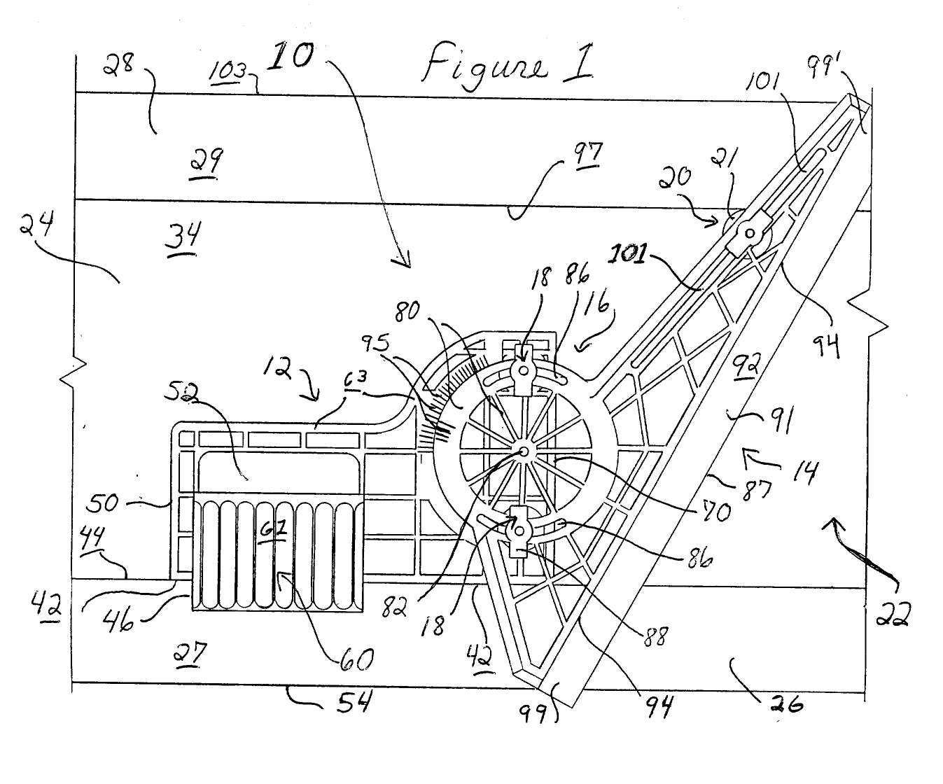

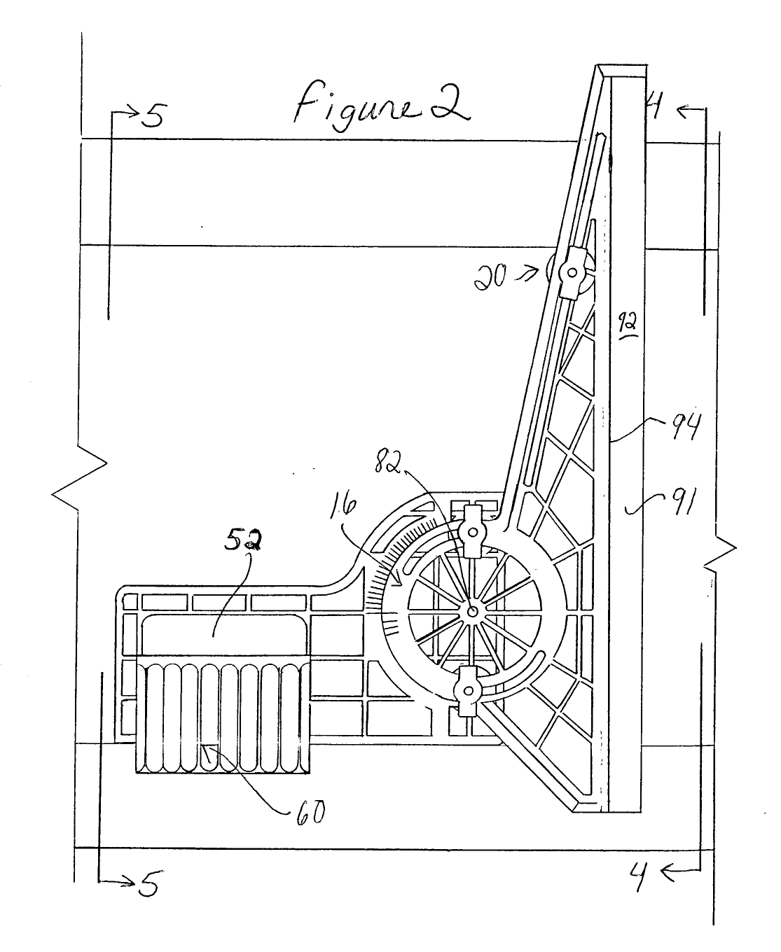

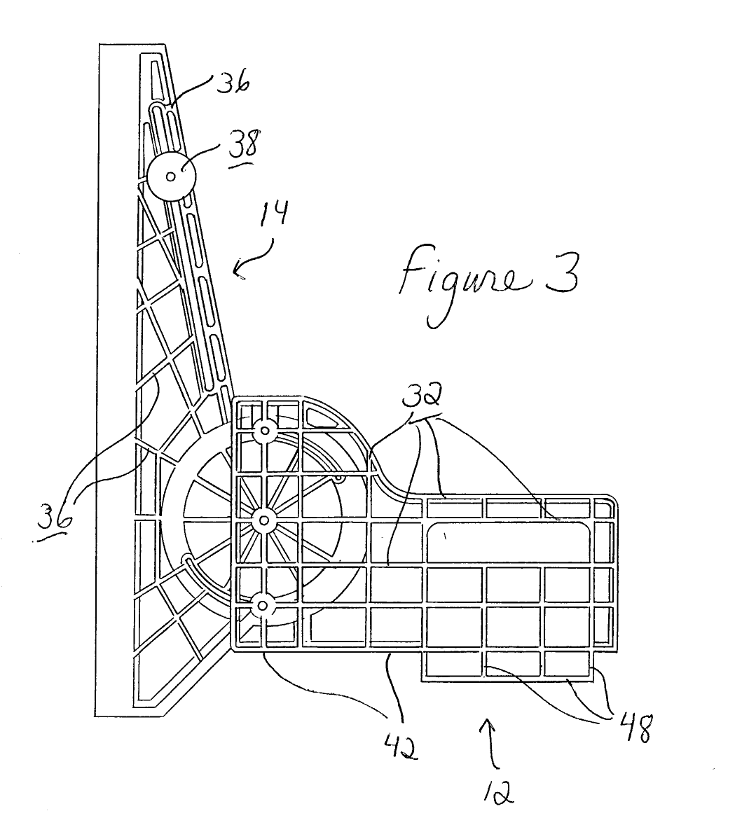

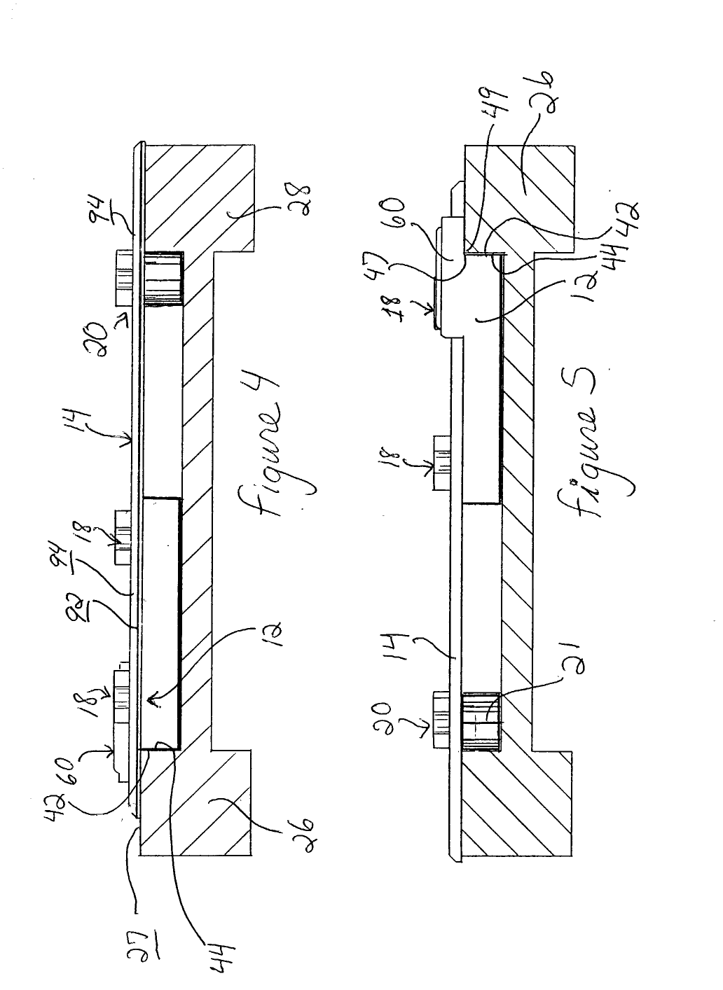

First member 12 edge surface 42 rests against and abuts the inner surface 44 of the first flange 26. While it is preferred than this edge surface 42 is about ½-⅔ the width of the I-beam so that it extends quite a distance along the first flange, it may be various lengths as long as it fulfills the goal of being a hand grip member sufficient in length to assist the user to hold the saw guide firmly on the I-beam. The length of the edge surface 42, along with the stop system 20 discussed below, aids in anchoring the saw guide for safe use. The first member 12 preferably also comprises a ledge 46 that extends a part of the way across the top surface 27 of the first flange 26. Thus, the edge surface 42 and the bottom 48 of the ledge 46 form about a 90 degree corner 47 that receives the top inner corner 49 of the first flange. Near the outer end 50 of the first member 12 is located finger aperture 52 or recess that receives the user's fingers, typically of his/her left hand in the orientation of FIG. 1. The palm of the user's hand extends across the top surface of the first member near the outer end 50 and the user's thumb and thenar eminence portion of the hand rest/grip the outer surface 54 of flange 26. Thus, the portion of the first member 12 nearest the first flange 26 forms handle 60 and is sized to have a width for an average hand. Gripping the handle tends to force the first portion 12 against the inner surface 44 of the flange toward the user. The inventors have found that this handle, along with the other safety features discussed below, are an efficient way of anchoring the saw guide 10 on/in the I-beam without the need for any clamp, fastener, or other means for attaching the saw guide to the I-beam. As further discussed below, the saw guide 10 rests on the I-beam, and presses outward on both the flanges, but is not clamped, attached, bolted or pegged to the I-beam.

The first member 12 is preferably a generally flat plate shape, with the first member 12 being about the same thickness at its outer end 50 as near inner end 70. An exception to this is preferably the handle top surface 61, which is slightly raised relative to the rest of the first member top surface 63, so that it can extend out across the flange and be contoured or grooved to give a secure and comfortable grip.

On the top surface 63 of the first member 12 near the inner end 70 rests the central region 80 of the second member 14. The second member 14 is generally a flat plate shape, parallel to first member 12. At pivot point 82, the first member 12 and second member 14 are rotatably/pivotally connected, that is, the second member 14 rotates around the axis at point 82 that extends normal to the planes of the first member and second member. The pivot point 82 may be of various designs of rotating axis, including a simple pin axis without bearings. Two locks 18 extend up from the first member 12, pass through apertures 86 in the second member, and connect to wing nuts 88 or other tighteners. By tightening the wing nuts 88, force is applied on the top of the second member to compress the second member central region 80 between the wing nuts 88 and the first member and, hence, lock the two members relative to each other. Having two independent locks 18, preferably at 180 degrees from each other around the pivot point 82 or a plurality of more than two locks otherwise spaced apart, serves to more tightly and reliably lock the second member 14 relative to the first member 12 in a particular orientation (angle).

The outer edge 90 of the second member 14 runs along the length of the second member and is an elongated support member 91 with an upper support surface 92 for supporting the saw during cutting so that the saw is supported slightly above the plane of the top surfaces 27,29 of the flanges, and not interfered with by the differences of thickness of the web and the flanges. The support member 91 and its support surface 92 both have a length that is greater than the width of the I-beam, preferably about 1.5 times the width of the I-beam, but this will vary depending on the I-beam being cut. Preferably, the support member 91 and support surface 92 are long enough to span all across the I-beam even at cutting angles corresponding to the greatest pitch angles, for example, a 14-12 pitch or a 16-12 pitch. Thus, the support member rests firmly and predictably on the top surfaces 27, 29 of the flanges and the support surface extends all the way across the I-beam, for safe and accurate cutting, no matter at what angle the second member is set relative to the first member and I-beam length. It may be noticed that the bottom surface 93 of the support member and the (top) support surface 92 are substantially parallel, flat and planar along their entire lengths all the along the length of the second member. This way, the second member and the saw are supported flat and parallel to the top surface 34 of the web and the top surfaces 27, 29 of the flanges. Also, this way, there are no protrusions downward from the second member that interfere with the unlocked second member being pivoted/rotated to any of many angles relative to the I-beam length, except the movable stop system that is purposely moved out of the way for adjustment of the second member angle and then locked in place against the second flange. Also, the second member 14 and the support member 91 are rigid and strong enough to minimize the bowing or sagging of the support member on the I-beam during cutting from the force and weight of the saw. At a minimum, however, the support member is strong and rigid enough so that any sagging on the I-beam (which is more likely the wider the I-beam and the greater the pitch angle) does not permanently bend and bow the support member, but, rather, the support member spring back to its original shape after the saw is removed from it.

Adjacent to the support surface 92 and preferably spaced in from the extremity edge 87 about 1.5 inches (which is preferred for the conventional worm-drive saw used by many professional carpenters), elongated guide surface 94 extends up perpendicular to the support surface 92 to be perpendicular to the web top surface 34 and flange top surfaces 27, 29. Thus, it may be said that, when the I-beam if placed horizontally on a surface, and the saw guide 10 is installed horizontally on the I-beam, the support surface 92 is also horizontal, and the guide surface 94 extends vertically up from the support surface. The support surface 92 serves to keep the saw in a horizontal plane. The guide surface 93 serves to keep the saw on a straight line during cutting of the I-beam, which causes the cut across the I-beam to be parallel to the guide surface, and, hence, at the same angle relative to the longitudinal axis of the I-beam and lengths of the flanges. Thus, it may be seen, that, by locking the second member 14 relative to the first member 12, one is actually choosing the angle of the guide surface 93 to the first member edge surface 42. Because the edge surface 42 abuts against the flange 26, the guide surface 93 is therefore set at that chosen angle relative to the flange. The central region 80 of the second member preferably has indicia 95 on both the first member and second member that indicate the chosen angle in degrees, so that a reproducible, accurate angle may be chosen. The angle of the guide surface, therefore, is perpendicular to the top surfaces of the web and flanges of the I-beam, and at an angle relative to the length of the I-beam. By running the saw along the guide surface and the support surface, the saw is controlled in a straight line in a horizontal plane for accurate and safe cutting.

In some embodiments, the extremity edge is adapted so that it may be shaved off to an exact fit for the user's particular saw, at the time of the user's first cut with that saw guide, by the saw itself doing the shaving during the first cut of the I-beam. This way, a user tends to use the same saw guide with the same saw, and that saw guide has a support surface properly sized for that saw, that is, with the extremity edge being spaced accurately from the guide surface 94 to match that particular saw's dimensions.

Preferably, a stop system 20 is used to create an abutment member that presses out against the inner surface 97 of flange 28, adapting the saw guide 10 to “press” out against the inner surfaces of the both flanges for secure and non-rotational use. The stop system is preferably a linearly-adjustable member, for example, a snubber member 21 that may be moved and locked in place at various locations along the length of the support member, in effect, providing a “leg” that preferably both extends down to the web and presses out against the inner surface 97. The snubber pressing out against the inner surface 97, or, preferably at a minimum being very closely adjacent to the inner surface 97, prevents rotation of the saw guide in its entirety or the second member (if loosened accidently), by the force of the saw moving and cutting from end 99 to end 99′ and pressing against the guide surface 94. The force of the saw would tend to rotate the second member counter-clockwise in FIG. 1 relative to the pivot point 82, and, hence, the snubber 21 forms an effective bumper/stop against such counter-clockwise movement. Also, abutment of the first member edge surface 42 stops counter-clockwise movement of the locked saw guide. It should be noted that the user will stand, in effect, at the bottom of FIG. 1, and, with his/her right hand, will move the saw toward the top of the FIG. 1, pushing it along the support member. Any need for a left-handed version of saw guide 10 may easily be met and explained by manufacturing a mirror image of the drawn saw guide 10.

The stop system 20 may be designed to be a snubber unit that is lockable by a wing-nut, round nut or triangular nut, for example, and that is slidable in an elongated slot 101, or otherwise slidable along a path parallel to the length of the saw support member. The lower portion of the snubber 21 is preferably a rigid or non-compressible material, and may be a non-compressible material with a surface that tends to grip the wooden I-beam, so that the snubber 21 grips the inner surface 97 and preferably the web top surface 34, preferably without any significant compression of the snubber material. This preferred structure provides a secure and stable placement of the invented tool on the I-beam without slippage and shifting relative to the I-beam. For example, Delrin™ acetal resin or other plastics, synthetic materials, or even natural materials may be used for the snubber lower portion.

Preferably, the snubber is cylindrical and is pushed as far as possible with normal strength against the flange 28, so that the saw guide fits fairly tightly in between the flanges. The snubber 21 preferably is not significantly compressible, so that the force of cutting the I-beam does not compress the snubber and shift the saw guide. Optionally, but not preferably, the stop system 20 may include a cam design to more forcefully press the snubber out against the inner surface.

The invented saw guide in designed for adjustment to a wide range of angels, for example all the way from 30 degrees relative to the first flange 26 continuously to 90 degrees relative to the first flange 26. The indicia 95 may be designed to indicate degree of angle and/or pitch, as may be preferred by carpenters. For example, the proper angle for cuts to produce roof pitches of 4 feet, 6 feet, 8 feet, etc., in 12 feet of roof width may be indicated in the indicia 95.

Once the invented saw guide 10 is locked in a desired angle, the saw guide may be used over and over again for cutting that angle, without further adjustment. Because the saw guide may be lifted off the I-beam without loosening the locks 18, the angle need not be changed until a different angle is desired. The snubber stop system 20 may be loosened prior to removal from the I-beam and then re-locked in proper position when the saw guide is replaced on another I-beam. More likely, the saw guide 10 may be moved or pivoted enough on the I-beam, once the user's hand releases handle 60, to lift the saw guide 10 off the I-beam without loosening the stop system and then replaced, without readjusting the stop system or the pivot, on an I-beam of the same dimensions for a cut of the same angle.

The invented saw guide features simple, accurate, and efficient means for cutting I-beams at angles or even transverse to the length of the I-beam. The invented saw guide does not require clamps or moving parts except for the pivotal connection between the first member and the second member, and, preferably, also the stop system. The invented saw guide preferably does not extend around the flanges to clamp to, grip, or otherwise contact the outer surfaces 54, 103 of the flanges. The saw guide works, instead, by being installed tightly inside the flanges with frictional engagement with the web surface and the flange inner surfaces, and by resting also on the top surfaces of the flanges. One may see that the invented saw guide design may be easily scaled up or down to fit various sizes of I-beams, and that one size may be used on a variety of widths of I-beams because the snubber is adjustable to fit the width of the particular I-beam at any particular chosen cut angle.

The invented saw guide is preferably made of injection-molded ABS (Acrylonitrile Butradiene Styrene), but may be of other preferably durable, strong, and rigid materials.

Although this invention has been described above with reference to particular means, materials and embodiments, it is to be understood that the invention is not limited to these disclosed particulars, but extends instead to all equivalents within the scope of the following claims.

I/we claim:

1. A saw guide for supporting a hand-held power saw during cutting of an I-beam, the I-beam comprising a web, and a first flange and second flange, the first flange and second flange having inner surfaces perpendicular to the web top surface and facing each other, and the first flange and second flange having outer surfaces perpendicular to the web top surface and facing outward away from the web, the saw guide comprising:
a first member and a second member in parallel planes and pivotally connected together to pivot relative to each other in their parallel planes; and
wherein the entire saw guide rests between and on top of the first flange and the second flange and none of the saw guide extends to contact the outer surfaces of the first flange or the second flange.

2. A saw guide as in claim 1, comprising a securement system for preventing the saw guide from pivoting on the I-beam during cutting of the I-beam, the securement system comprising:
the first member having an abutment surface for abutting against the inner surface of the first flange and the second member having a moveable abutment surface for abutting against the inner surface of the second flange.

3. A saw guide as in claim 1, wherein the first member and the second member pivot relative to each other at a pivot point, and the moveable abutment surface is a slidable, lockable member that slides to positions various distances from the pivot point.

4. A saw guide as in claim 1, wherein the first member further comprises a finger aperture from a top surface to a bottom surface of the first member, the finger aperture for receiving fingers of a user while the user grasps the first member and the first flange.

5. A saw guide as in claim 4, wherein the first flange has a top surface, and the first member further comprises a handle extending partially across the first flange top surface.

6. A saw guide as in claim 1, wherein the saw guide comprises no clamping means to clamp the saw guide to the I-beam.

7. A saw guide as in claim 1, wherein the second member has a two ends and a length between the two ends, and a central region, wherein the central region has a pivot point at which the second member is pivotally connected to the first member and the upper support surface extends along the entire length of the second member.

8. A saw guide as in claim 7, wherein the two ends of the second member are adapted to rest of the top surfaces of the first flange and second flange.

9. A saw guide as in claim 1, wherein the web has a web top surface, and the second member outer region has a bottom surface facing the web top surface, and the outer region bottom surface has no downward protrusions except the movable abutment surface.

10. A saw guide according to claim 1 comprising two independent locks that lock the second member in position relative to the first member.

11. A saw guide for supporting a hand-held power saw during cutting of an I-beam, the I-beam comprising a web with a length, a top surface and two longitudinal edges, and a first flange and second flange at the two longitudinal edges, a width between the first flange and second flange, the first flange and second flange each having inner surfaces perpendicular to the web top surface and parallel to the web length, the saw guide comprising:
a first member and a second member in parallel planes and pivotally connected together to pivot relative to each other in their parallel planes; and
a securement system for preventing the saw guide from pivoting on the I-beam during cutting of the I-beam, the securement system comprising:
the first member having an abutment surface for abutting against the inner surface of the first flange and the second member having a moveable abutment surface for abutting against the inner surface of the second flange.

12. A saw guide as in claim 11, further comprising a saw support member having two ends and a length between the two ends and extending all the way across the width of the I-beam.

13. A saw guide as in claim 12, wherein the saw support member has an upper support surface and the saw support member further comprises a guide surface upending from the upper support surface, the upper support surface and the guide surface extend all the way from end to end on the saw support member.

14. A saw guide as in claim 12, wherein the moveable abutment surface comprises a snubber member extending down from the second member and lockably sliding along a path parallel to the length of the saw support member.

15. A saw guide as in claim 11, wherein the first member abutment surface is an elongated planar side surface of the first member.

16. A saw guide for supporting a hand-held power saw during cutting of an I-beam, the I-beam comprising a web with a length, a top surface and two longitudinal edges, and a first flange and second flange at the two longitudinal edges, the first flange and second flange each having inner surfaces perpendicular to the web top surface and parallel to the web length, the saw guide comprising:
a first member lying in a plane parallel to an I-beam web and having an elongated abutment surface adapted for abutting against the inner surface of the first flange of an I-beam to be cut;
a second member pivotally connected to the first member to pivot in a plane parallel to the web top surface, the second member having an outer region with an upper support surface generally parallel to the web top surface for supporting a power saw, the outer region having a guide surface perpendicular to and upending from the upper support surface for guiding the saw to cut the I-beam;
wherein the second member is pivotal to place the guide surface at various angles relative to the length of the web, and the second member is securable in the various angles to temporarily fix the angle;
a stop system comprising a movable abutment member that is movable to, and lockable in, various positions along a line parallel to the guide surface, the abutment member for pressing against the inner surface of the second flange;
wherein the abutment surface and the movable abutment member prevent significant movement of the saw guide relative to the I-beam during cutting of the I-beam.

17. A saw guide according to claim 16, wherein the first member further comprises a finger aperture from a top surface to a bottom surface of the first member near the web, the finger aperture for receiving fingers of a user while the user grasps the first member and the first flange.

18. A saw guide according to claim 16, wherein the first member further comprises a finger recess from a top surface to near a bottom surface of the first member near the web, the finger recess for receiving fingers of a user while the user grasps the first member and the first flange.

19. A saw guide according to claim 17, wherein the first flange has a top surface, and the first member further comprises a handle extending partially across the first flange top surface.

20. A saw guide according to claim 18, wherein the first flange has a top surface, and the first member further comprises a handle extending partially across the first flange top surface.

21. A saw guide according to claim 16, wherein the first flange and the second flange each have an outer surface parallel to the flange inner surfaces, and wherein the saw guide does not extend to contact the outer surfaces of the first and second flanges.

22. A saw guide according to claim 16, wherein the first flange and the second flange each have an outer surface parallel to the flange inner surfaces, and wherein the saw guide comprises no clamping means that extends over either the top surface of either the first or second flange to contact the outer surface of either the first and second flange.

23. A saw guide according to claim 16, wherein the second member has a two ends and a length between the two ends, and a central region, wherein the central region has a pivot point at which the second member is pivotally connected to the first member and the upper support surface extends along the entire length of the second member.

24. A saw guide according to claim 23, wherein the two ends of the second member are adapted to rest of the top surfaces of the first flange and second flange.

25. A saw guide according to claim 16, wherein the second member outer region has a bottom surface facing the web top surface, and the outer region bottom surface has no downward protrusions except the movable abutment member.

26. A saw guide according to claim 16 comprising two independent locks that lock the second member in position relative to the first member.
